(19) United States
(12) Patent Application Publication
(10) Pub. No.: US 2011/0251864 A1
(43) Pub. Date: Oct. 13, 2011

(54) METHOD AND SYSTEM FOR MITIGATING SURVEY FRAUD

(75) Inventors: Mike WARNER, Winnipeg (CA); Jeff SAUNDERS, Winnipeg (CA)

(73) Assignee: TELL US ABOUT US INC., Winnipeg (CA)

(21) Appl. No.: 13/081,677

(22) Filed: Apr. 7, 2011

(30) Foreign Application Priority Data
Apr. 9, 2010 (CA) 2699616

(51) Int. Cl. G06Q 10/00

(52) U.S. Cl. 705/7.11

(57) ABSTRACT

A method and system for mitigating survey fraud is provided. Survey responses stored in storage of a computer system are analyzed. The survey responses include identifiers associated with computing devices of users providing the survey responses. The number of the survey responses is totaled for each of the identifiers. The identifiers for which the number of the survey responses meets a threshold are identified as belonging to suspected gamers. At least some of the survey responses for the identifiers identified as belonging to suspected gamers are flagged as invalid.

### FIELD OF THE INVENTION

The present invention relates generally to data collection and, more specifically, to a system and method for mitigating survey fraud.

### BACKGROUND OF THE INVENTION

It can be desirable for companies to measure their performance and tailor their services using customer feedback provided via surveys. The customer feedback can assist in assessing the performance of various entities of a business. Examples of such entities can include products, services, retail locations, teams of employees and individual employees.

In some of these cases, it can be desirable for people to skew the results of the surveys for various reasons. For example, one or more employees at one retail location can fraudulently complete the survey as if they were customers of their retail location, providing very positive feedback in order to boost their performance measurement. Such people are deemed to be “playing” the survey system and are thus hereinafter referred to as “gamers”.

It is therefore an object of the invention to provide a novel method and system for mitigating survey fraud.

### SUMMARY OF THE INVENTION

In accordance with an aspect of the invention, there is provided a method for mitigating survey fraud, comprising:

analyzing survey responses stored in storage of a computer system, said survey responses including identifiers associated with computing devices of users providing said survey responses;

totalling the number of said survey responses for each of said identifiers;

identifying said identifiers for which the number of said survey responses meets a threshold as belonging to suspected gamers; and

flagging as invalid at least some of said survey responses for said identifiers identified as belonging to suspected gamers.

The totalling can include totalling the number of the survey responses for each of the identifiers during a time period.

The flagging as invalid can include flagging as invalid the survey responses for the identifiers identified as belonging to suspected gamers in excess of a pre-defined number.

The identifiers identified as belonging to suspected gamers can be added to a first list.

The method can further include:

flagging as valid all of said survey responses for said identifiers included in a second list.

The method can further include:

segregating complete ones of said survey responses from incomplete ones of said survey responses.

The identifiers can be CallerIDs, IP addresses or MAC addresses.

In accordance with another aspect of the invention, there is provided a computer system for mitigating survey fraud, comprising:

storage storing computer-executable instructions, and a set of survey responses;

a processor for executing said computer-executable instructions for analyzing said survey responses including identifiers associated with computing devices of users providing said survey responses, totalling the number of said survey responses for each of said identifiers, identifying said identifiers for which the number of said survey responses meets a threshold as belonging to suspected gamers, and flagging as invalid at least some of said survey responses for said identifiers identified as belonging to suspected gamers.

The processor can total the number of the survey responses for each of the identifiers during a time period.

The processor can flag as invalid the survey responses for the identifiers identified as belonging to suspected gamers in excess of a pre-defined number.

Identifiers identified as belonging to suspected garners can be added by the processor to a first list.

The processor can flag as valid all of the survey responses for the identifiers included in a second list.

The processor can segregate complete ones of the survey responses from incomplete ones of the survey responses.

The identifiers can be CallerIDs, IP addresses or MAC addresses.

In accordance with a further aspect of the invention, there is provided a computer-readable medium having stored thereon computer-executable instructions for mitigating survey fraud when executed on a computer system, said computer-executable instructions including code for analyzing survey responses stored in storage of said computer system including identifiers associated with computing devices of users providing said survey responses, for totalling the number of said survey responses for each of said identifiers, for identifying said identifiers for which the number of said survey responses meets a threshold as belonging to suspected garners, and for flagging as invalid at least some of said survey responses for said identifiers identified as belonging to suspected garners.

### BRIEF DESCRIPTION OF THE DRAWINGS

Embodiments will now be described, by way of example only, with reference to the attached Figures, wherein:

FIG. 1 shows a schematic representation of a computer system for mitigating survey fraud in accordance with an embodiment of the invention, and its operating environment;

FIG. 2 shows a high-level architecture for the computer system of FIG. 1;

FIG. 3 shows the general method of processing survey responses employed by the computer system of FIG. 1;

FIG. 4 shows the process of identifying callers suspected of fraudulently responding to surveys in a time period in the method of FIG. 3 in greater detail; and

FIG. 5 shows the process of identifying survey responses suspected of being fraudulent in the method of FIG. 3 in greater detail.

### DETAILED DESCRIPTION OF THE EMBODIMENTS

Survey fraud presents a serious issue for organizations attempting to obtain feedback on its overall image, service and products, as well as for various entities within the organization, such as service received at retail locations, particular products, or even service provided by groups or single employees. Many organizations rely on such feedback in evaluating itself and its entities. Where applicable, surveys enable specification of the entity being evaluated. Accordingly, it is desirable for the responses to these surveys to be unbiased and even somewhat representative of the opinions of the target demographics of the surveys.

As the results of such surveys can impact the evaluation of entities, there are numerous parties that can have vested interests in affecting such survey results, either positively or negatively. It may be of interest to some parties to have survey results lead to a more favorable evaluation for entities. For example, employees at a store location may boost their particular store location's image by submitting numerous favorable survey responses. In a similar manner, the same employees may desire to have the survey results portray other store locations in a less favorable light, thus indirectly making their store location appear more favorable relatively.

In many cases, such “garners” often submit fraudulent survey responses repeatedly in an effort to significantly impact the evaluation of an entity. By identifying trends associated with the identity of users completing survey responses, the impact that such survey fraud has on the results of a survey can be mitigated.

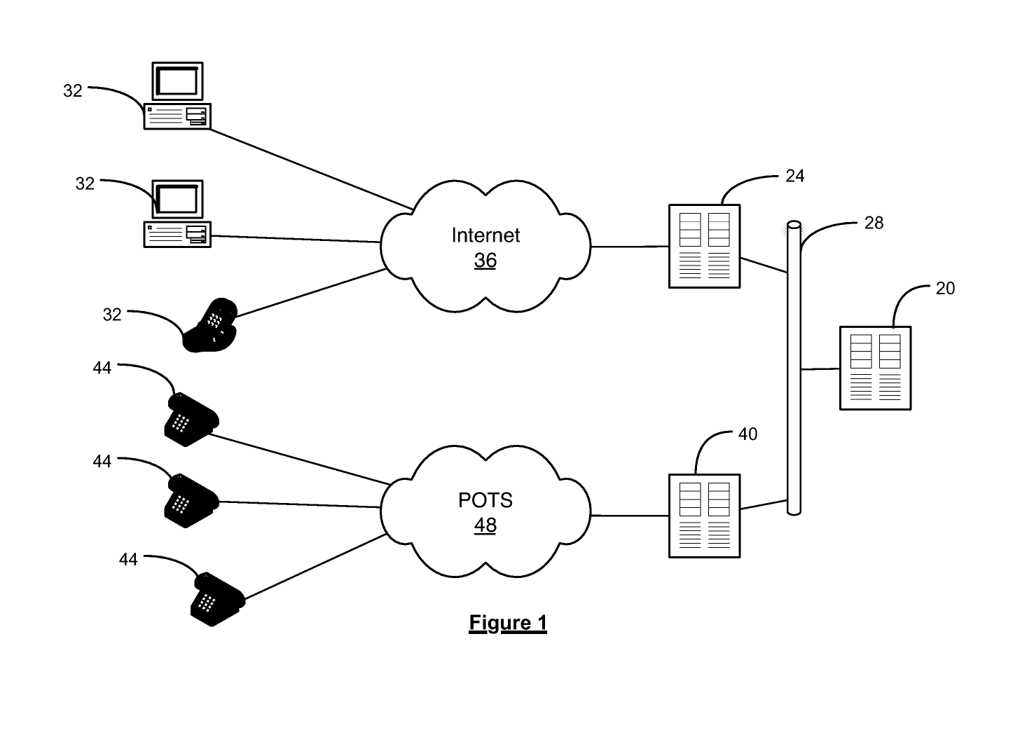

FIG. 1 shows a computer system 20 for mitigating survey fraud in accordance with an embodiment of the invention, and its operating environment. The computer system 20 is in communication with a web server 24 over a local area network (“LAN”) 28. The web server 24 hosts a web-based survey application that presents one or more surveys, each including a set of survey questions, via one or more survey form web pages for completion by users using computing devices 32 in communication with the web server 24 via the Internet 36. As shown, the computing devices 32 can include, for example, general purpose computers and mobile phones with mobile browsers. In addition to the survey responses, the web-based survey application registers an identifier and other information identifying the computing device and/or user. In particular, the identifiers here are Internet Protocol (“IP”) address or Media Access Control (“MAC”) addresses that are associated with the computing devices. The computer system 20 is also in communication with a public branch exchange (“PBX”) 40. The PBX 40 includes an interactive voice response (“IVR”) survey application that enables users employing telephony devices 44 in communication with the PBX 40 over a plain old telephone system (“POTS”) 48 to interact with the IVR survey application through voice recognition to complete a survey that includes a set of survey questions. In addition to responses to the survey questions, the IVR survey application registers an identifier of the telephony devices 44, along with any other information identifying the telephony devices and/or users. In particular, the identifiers registered here are the CalledDs of the telephony devices.

The web server 24 and PBX 40 perform surveys for a number of client companies. For each client company, information is collected to permit the following information to be set up in a client table:
Identity (pk): This is simply a unique identifier assigned to each record in the client company rule table. There is one record per client company.
COID (fk-Corporate Office): This is a user-friendly identifier that identifies the client company for each record.
Time period: This is a time interval for which survey results are summarized, as requested by the client company. Client companies may wish to have summaries prepared with different frequencies (e.g., by month, day, week, hour, etc.) depending on their needs.
ResponseThreshold: This parameter identifies how many survey responses can be received from a particular CallerID/IP address during the time period specified by the client company before the CallerID/IP address is flagged as a suspected gamer. This is specified by the client company.
NumberOfResponsesToLeaveActive: This parameter identifies how many survey responses received during the time period that the client company wishes to leave in the active data from a CallerID/IP address that has been identified as being a suspected gamer for that time period. If this number is set higher than the ResponseThreshold, then the ResponseThreshold is used.

The web-based survey application executing on the web server 24 and the IVR survey application executing on the PBX 40 are provided, for each client company, the Identity and the COID fields so that as survey responses are collected, each survey response can be associated with the appropriate client company and a particular entity (i.e., branch, location, product, team, employee, etc.) that is being evaluated.

The computer system 20 receives and processes the survey responses registered by the web-based survey application executing on the web server 24 and by the IVR survey application executing on the PBX 40. Each survey response is represented by a survey response record that holds information about the device used by the user, such as the computing device's associated CallerID or IP address, the time the survey response was started and the actual responses to the survey questions. The computer system 20 identifies suspected gamers and associated survey responses using the survey response records and handles them as detailed below.

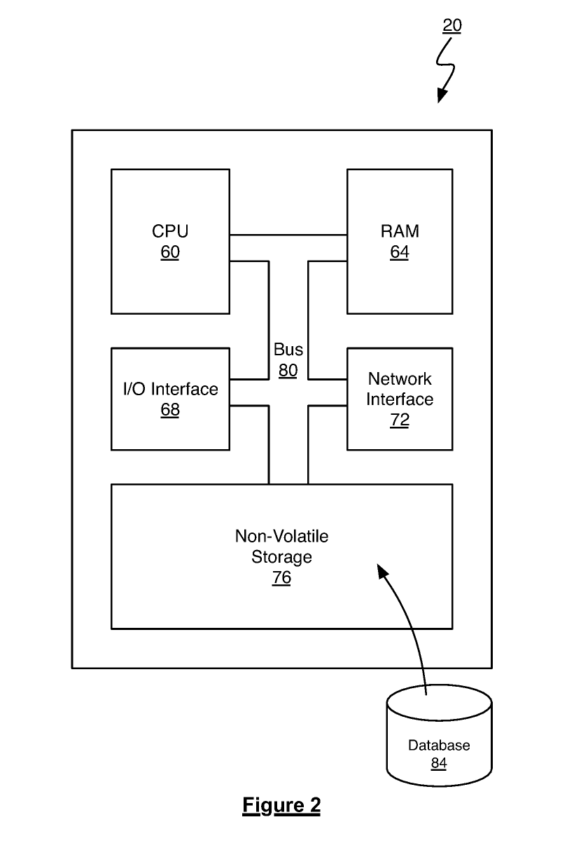

FIG. 2 shows various physical and logical elements of the computer system 20 for mitigating survey fraud. As shown, the computer system 20 has a number of physical and logical components, including a central processing unit (“CPU”) 60, random access memory (“RAM”) 64, an input/output (“I/O”) interface 68, a network interface 72, non-volatile storage 76, and a local bus 80 enabling the CPU 60 to communicate with the other components. The CPU 60 executes an operating system, a stateful data sharing service and a number of software systems. RAM 64 provides relatively-responsive volatile storage to the CPU 24. The I/O interface 32 allows for input to be received from one or more devices, such as a keyboard, a mouse, etc., and outputs information to output devices, such as a display and/or speakers. The network interface 72 permits communication with the web server 24 and the PBX 40 via the LAN 28. Non-volatile storage 76 stores the operating system and programs, including computer-executable instructions for implementing survey fraud mitigation software for mitigating survey fraud, and the survey fraud mitigation software's data. A database 84 stored in non-volatile storage 76 stores various rules and lists, as will be described below. During operation of the computer system 20, the operating system, the programs and the data may be retrieved from the non-volatile storage 76 and placed in RAM 64 to facilitate execution.

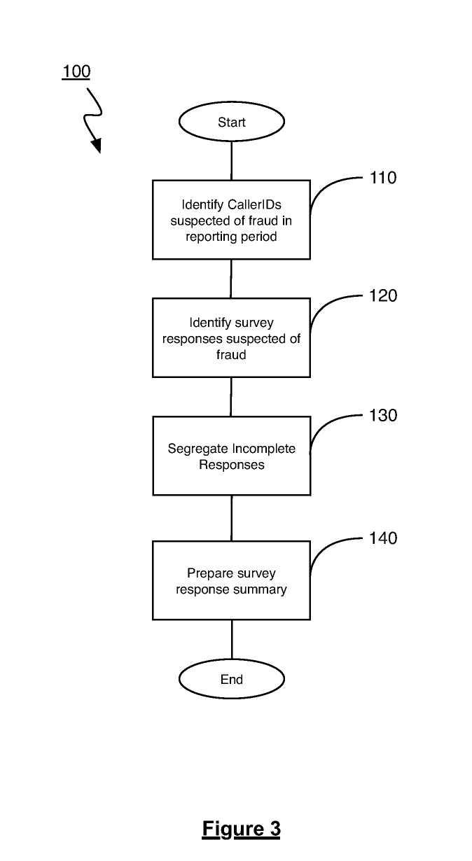

FIG. 3 shows the general method of processing survey responses for each time period used by the computer system 20 generally at 100. For ease of understanding, the method 100 will be described with respect to the processing of the IVR survey application's data.

The method 100 commences with the identification of CallerIDs suspected of fraud in a time period by the computer system 20 (110). Using the CallerIDs identified as suspected of fraud, the survey responses suspected to be fraudulent are identified (120). Incomplete survey responses are segregated from complete survey responses (130). The computer system 20 then prepares a survey response summary (140).

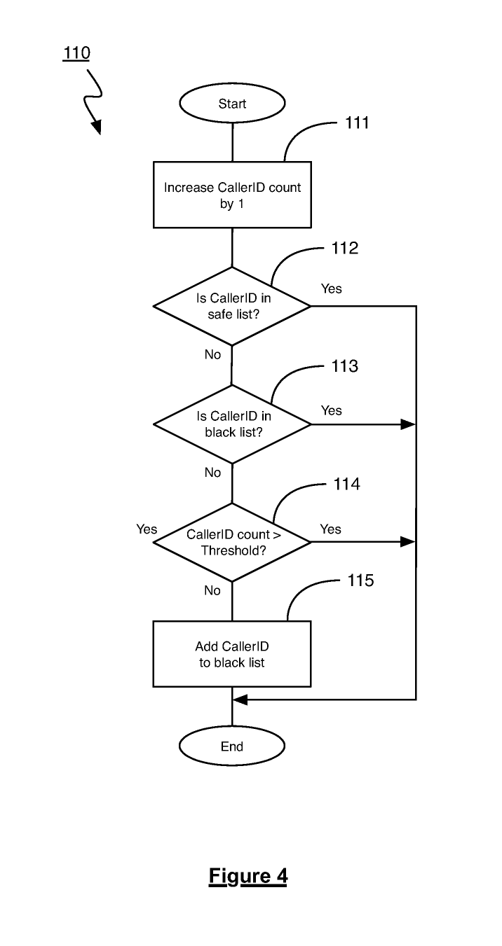

FIG. 4 shows in greater detail the steps performed during the identification of CallerIDs suspected of fraudulently submitting survey responses. The survey response records are retrieved by the computer system 20 from the PBX 40 and processed one by one as follows.

The CallerID count for the CallerID identified in the particular survey response record being examined is increased by one (step 111). The computer system 20 keeps a tally of the number of records associated with each CallerID. The computer system 20 then determines if the CallerID identified in the survey response record is flagged as active in a safe list provided by the client company (step 112).

A safe list is established for each client company. The safe list includes the following fields:
Identity (pk): This is a unique identifier for records in the safe list table.
SRCFCID (fk): This field defines the Survey Response CallerID Fraud Configuration for a particular client company for which the record in the safe list is defined.
CallerID (fk): This is simply the CallerID that is safe-listed; i.e., that will not be analyzed when the fraud detection logic is executed for the SRCFCID client company. Note that a CallerID may be safe-listed for one client company but may be black-listed or not listed for other client companies.
Active (bit flag): This is a flag that indicates whether the particular record of the safe list is active (i.e., whether the ClientID is, in fact, actively considered safe). A client company may wish to temporarily deactivate a safe-listed CallerID. Flagging the record as inactive in this table automatically removes the protection afforded to the CallerID identified in the record until the flag is reset to active.
Notes (text): This is a comments field that permits entry of notes regarding why a particular CallerID was placed on the safe list.

The safe list can be used to address issues in certain cases. For example, in the case of the web-based survey application, survey responses originating from certain Internet service providers and locations may share the same IP address. In such situations, it can be desirable to “safe list” that particular IP address to ensure that valid survey responses from users using that Internet service provider, etc. are received.

If the CallerID identified in the survey response record is flagged as active in the safe list, the survey response record is deemed valid and no further checks are performed. If the CallerID identified in the survey response record is not in the safe list or is not marked active, the computer system 20 determines whether the CallerID identified in the survey response record is already in a black list for the currently-analyzed time period (step 113).

The black list to which CallerIDs identified as being suspected gamers are added is a table that includes the following fields:
Identity (pk): This is a unique identifier (key) for each record in the black table.
SRCFCID (fk): This field identifies the client company configuration, referred to as the Survey Response CallerID Fraud Configuration, that detected the CallerID as a suspected gamer, thus causing the creation of this black list entry.
ResponsePeriod (fk): This is the time period for which the CallerID was added to the black list; i.e., the time period for which the CallerID was identified as being suspected of fraudulently responding to one or more survey(s).
CallerID (fk): This is simply the CallerID suspected of gaming.

If the CallerID is in the black list, no further checks are performed for the particular survey response record and the computer system 20 selects the next survey response record for analysis. If, instead, the CallerID is not in the black list for the currently-analyzed time period, the computer system 20 determines if the CallerID count (corresponding to the number of survey response records in which the CallerID was identified for that time period) exceeds the ResponseThreshold for the time period, as specified by the client company (step 114). If the CallerID count exceeds the ResponseThreshold, the CallerID is added to the black list for the currently-analyzed time period (step 115).

Once all survey response records have been analyzed and the black list of CallerIDs identified as suspected gamers is identified, the survey response records suspected of being fraudulent (i.e., that are associated with the CallerIDs on the black list for the time period) are dealt with as follows.

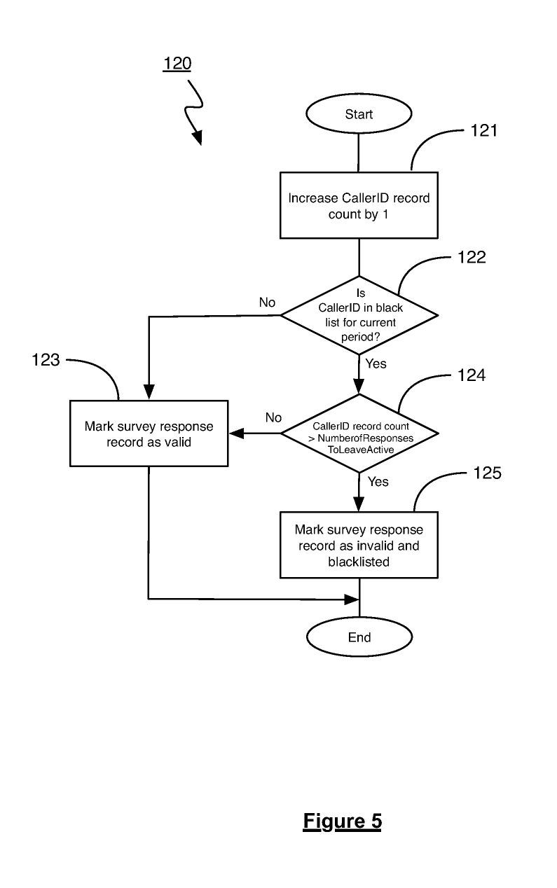

FIG. 5 shows the steps performed during the processing of each survey response record in view of the black list. The computer system 20 processes the survey response records sequentially one-by-one. A count for survey response records for the CallerID identified in the survey response record being processed by the computer system 20 is augmented by one (step 121). The computer system 20 then determines if the CallerID identified in the survey response record is in the black list for the Time Period (step 122). If the CallerID is not in the black list, the record is flagged as valid (step 123). If, instead, the CallerID is in the black list, the CallerID record count is compared to the NumberOfReponsesToLeaveActive figure provided by the client company (step 124). If the CallerID record count is less than or equal to the NumberOfReponsesToLeaveActive parameter, the record is flagged as invalid due to blacklisting (step 125).

The valid records are then analyzed to determine which survey responses are incomplete at 130.

The survey response summary prepared at 140 provides a summary of the results of the survey for valid survey response records, and additional summaries for invalid survey response records. CallerIDs identified as being suspected of fraud are listed also in a separate summary. The client company can then go through the summaries and identify CallerIDs that it may wish to place on the safe list.

In addition, partially-completed survey responses can be identified by the client company as being somewhat useful. In this case, the client company can request that particular partially-completed survey responses be included in the overall results.

A summary of the suspected gamers for the time period is also provided to the client company and supports drilling in by location. This summary includes the following:
CallerID
number of survey attempts
number of incomplete responses
number of complete responses
number of responses marked as invalid through fraud detection logic

While the above discussion of the method used related to the IVR survey application, the same general method is used for the web-based survey application, with IP addresses replacing CallerIDs in identifying individual users/gamers.

While the computer system is shown as a single physical computer, it will be appreciated that the computer system can include two or more physical computers in communication with each other. Accordingly, while the embodiment shows the survey being carried out by separate machines, those skilled in the art will appreciate that the survey can be carried out by the computer system.

The survey response records can be left on the PBX, the web server, etc. and processed by the computer system remotely.

Computer-executable instructions for mitigating survey fraud when executed on a computer system could be provided separately from the computer system, for example, on a computer-readable medium (such as, for example, an optical disk, a hard disk, a USB drive or a media card) or by making them available for downloading over a communications network, such as the Internet.

The above-described embodiments are intended to be examples of the present invention and alterations and modifications may be effected thereto, by those of skill in the art, without departing from the scope of the invention that is defined solely by the claims appended hereto.

What is claimed is:

1. A method for mitigating survey fraud, comprising:
analyzing survey responses stored in storage of a computer system, said survey responses including identifiers associated with computing devices of users providing said survey responses;
totalling the number of said survey responses for each of said identifiers;
identifying said identifiers for which the number of said survey responses meets a threshold as belonging to suspected gamers; and
flagging as invalid at least some of said survey responses for said identifiers identified as belonging to suspected gamers.

2. The method of claim 1, wherein said totalling comprises:
totalling the number of said survey responses for each of said identifiers during a time period.

3. The method of claim 1, wherein said flagging as invalid comprises:
flagging as invalid said survey responses for said identifiers identified as belonging to suspected gamers in excess of a pre-defined number.

4. The method of claim 1, wherein said identifiers identified as belonging to suspected gamers are added to a first list.

5. The method of claim 1, further comprising:
flagging as valid all of said survey responses for said identifiers included in a second list.

6. The method of claim 1, further comprising:
segregating complete ones of said survey responses from incomplete ones of said survey responses.

7. The method of claim 1, wherein said identifiers are CallerIDs.

8. The method of claim 1, wherein said identifiers are IP addresses.

9. The method of claim 1, wherein said identifiers are MAC addresses.

10. A computer system for mitigating survey fraud, comprising:
storage storing computer-executable instructions, and a set of survey responses;
a processor for executing said computer-executable instructions for analyzing said survey responses including identifiers associated with computing devices of users providing said survey responses, totalling the number of said survey responses for each of said identifiers, identifying said identifiers for which the number of said survey responses meets a threshold as belonging to suspected gamers, and flagging as invalid at least some of said survey responses for said identifiers identified as belonging to suspected gamers.

11. The computer system of claim 10, wherein said processor totals the number of said survey responses for each of said identifiers during a time period.

12. The computer system of claim 10, wherein said processor flags as invalid said survey responses for said identifiers identified as belonging to suspected gamers in excess of a pre-defined number.

13. The computer system of claim 10, wherein said identifiers identified as belonging to suspected gamers are added by said processor to a first list.

14. The computer system of claim 10, wherein said processor flags as valid all of said survey responses for said identifiers included in a second list.

15. The computer system of claim 10, wherein said processor segregates complete ones of said survey responses from incomplete ones of said survey responses.

16. The computer system of claim 10, wherein said identifiers are CallerIDs.

17. The computer system of claim 10, wherein said identifiers are IP addresses.

18. The computer system of claim 10, wherein said identifiers are MAC addresses.

19. A computer-readable medium having stored thereon computer-executable instructions for mitigating survey fraud when executed on a computer system, said computer-executable instructions including code for analyzing survey responses stored in storage of said computer system including identifiers associated with computing devices of users providing said survey responses, for totalling the number of said survey responses for each of said identifiers, for identifying said identifiers for which the number of said survey responses meets a threshold as belonging to suspected gamers, and for flagging as invalid at least some of said survey responses for said identifiers identified as belonging to suspected gamers.
